(19) United States
(12) Patent Application Publication
(10) Pub. No.: US 2008/0269060 A1
(43) Pub. Date: Oct. 30, 2008

(54) Herbicidal Formulation

(75) Inventors: Andrew John Griffiths, Berkshre (GB); Rupert Heinrich Sohm, Muenchwilen (CH); Carl Andrew Formstone, Berkshre (GB)

Correspondence Address: SYNGENTA CROP PROTECTION , INC.;PATENT AND TRADEMARK DEPARTMENT, 410 SWING ROAD, GREENSBORO, NC, 27409, US

(73) Assignee: SYNGENTA CROP PROTECTION, INC., Greensboro, NC (US)

(21) Appl. No.: 11/570,820

(22) PCT Filed: Jun. 21, 2005
(86) PCT No.: PCT/GB05/02443

§ 371 Date: Jun. 1, 2007

(30) Foreign Application Priority Data
Jul. 2, 2004 (GB) 0414895.3

(51) Int. Cl. A01N 43/40; A01N 43/80; A01N 35/00; A01N 43/56; A01P 13/00

(52) U.S. Cl. 504/244; 504/271; 504/348; 504/282

(57) ABSTRACT

An aqueous pre-mix suspension concentrate formulation comprising: (i) water, (ii) an HPPD inhibitor, in suspension in the water, and (iii) an electrolyte, in solution in the water which has improved stability of the HPPD inhibitor is disclosed.

The present invention relates to a novel herbicidal formulation comprising an HPPD inhibitor and an, electrolyte, to its preparation, and to the use thereof. The invention further relates to a method of improving the stability of an HPPD inhibitor in water.

The protection of crops from weeds and other vegetation that inhibits crop growth is a constantly recurring problem in agriculture. To help combat this problem, researchers in the field of synthetic chemistry have produced an extensive variety of chemicals and chemical formulations effective in the control of such unwanted growth. Chemical herbicides of many types have been disclosed in the literature and a large number are in commercial use. Commercial herbicides and some that are still in development are described in The Pesticide Manual, 12^{th} edition, published in 2000 by the British Crop Protection Council.

Many herbicides also damage crop plants. The control of weeds in a growing crop therefore requires the use of so-called ‘selective’ herbicides, which are chosen to kill the weeds while leaving the crop undamaged. In practice, few herbicides are fully selective, in that they will kill all the weeds and leave the crop untouched at a particular application rate. The use of most selective herbicides is actually a balance between applying enough herbicide to acceptably control most of the weeds and causing only minimal crop damage.

One known selective herbicide is mesotrione, 2-(4-methylsulphonyl-2-nitrobenzoyl)cyclohexane-1,3-dione, an HPPD inhibitor. Mesotrione is not substantially soluble in water and has solubility of 2.2 g/l (pH 4.8), 15 g/l (pH 6.9) and 22 g/l (pH 9) all at 20° C. (data taken from The Pesticide Manual, 12^{th} Edition). Mesotrione is usually formulated for sale as a concentrated suspension of solid mesotrione in water. The concentrate typically contains between 100 and 500 g/l of mesotrione. This concentrate is then diluted by the end user, shortly before application, to give a final ready-to-use composition that typically comprises between 1 and 10 g/l of mesotrione.

One problem with mesotrione, and other HPPD inhibitors, is that it is unstable, that is it breaks down in the presence of water. The breakdown is slow, but results in a noticeable reduction in mesotrione content when the concentrate is stored for reasonable lengths of time, particularly in warm conditions. For example, a 10% SC formulation of mesotrione, stored at 54° C. for 2 weeks at pH 5 will decompose by approximately 45%.

It is therefore an object of the present invention to provide an improved aqueous pre-mix concentrate formulation comprising an HPPD inhibitor that is stable over a long period of time, particularly at a pH of greater than 3. A measure of whether a composition is stable is that there is less than 20%, suitably less than 10% decomposition in 2 years at ambient temperatures in a temperate climate.

We have surprisingly discovered that the long-term stability of an HPPD inhibitor in an aqueous environment can be improved by the addition of an electrolyte to the concentrate. This is a totally unexpeoted effect and allows for the storage of the HPPD inhibitor in the form of an aqueous suspension concentrate for much longer and/or under more severe conditions.

Accordingly, the present invention provides an aqueous pre-mix suspension concentrate formulation comprising:

(i) water,

(ii) an HPPD inhibitor, in suspension in the water, and

(iii) an electrolyte, in solution in the water.

Suitably the HPPD inhibitor is selected from the group consisting of isoxazoles, triketones, pyrazoles, benzobicyclon and ketospiradox.

Suitably, the isoxazole is a compound of formula (IA)

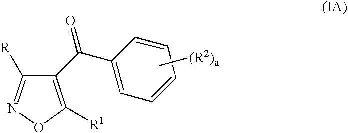

wherein R is hydrogen or —CO₂R³;

R¹ is C₁₋₄ alkyl or C₃₋₆ cycloalkyl optionally substituted by C₁₋₆ alkyl;

R² is independently selected from halogen, nitro, cyano, C₁₋₄ alkyl, C₁₋₄ haloalkyl, C₁₋₆ alkoxy, C₁₋₄haloalkoxy, —(CR⁴R⁵)CS(O)_{b}R⁶, —S(O)_{b}R⁶, —OSO₂R⁶ and —N(R⁷)SO₂R⁶; or two groups R², on adjacent carbon atoms of the phenyl ring may, together with the carbon atoms to which they are attached, form a 5- or 6-membered saturated or unsaturated heterocyclic ring containing up to three ring heteroatoms selected from nitrogen, oxygen and sulphur, which ring may be optionally substituted by one or more groups selected from halogen, nitro, C₁₋₄ alkyl, C₁₋₄ alkoxy, C₁₋₄ haloalkyl, C₁₋₄ haloalkoxy and —S(O)_{b}R⁶, it being understood that a sulphur atom, where present in the ring, may be in the form of a group —SO— or —SO₂—;

R³ is C₁₋₄ alkyl;

R⁴ and R¹ are independently hydrogen or C₁₋₄ alkyl;

R⁶ is C₁₋₄ alkyl, or phenyl or benzyl, each of phenyl and benzyl optionally bearing from one or five substituents which may be the same of different selected from the group consisting of halogen, C₁₋₄ alkyl, C₁₋₄ alkoxy, C₁₋₄ haloalkyl, C₁₋₄haloalkoxy, nitro and —S(O)_{b}CH₃;

R⁷ is hydrogen or C₁₋₆ alkyl;

a is an integer from one to five;

b is zero, one or two; and

c is one or two (where c is two, the groups (CR⁴R⁵) may be the same or different).

Suitably R is hydrogen; R¹ is cyclopropyl; R² is halogen (preferably chloro), —S(O)_{b}CH₃, or C₁₋₄ haloalkyl (preferably trifluoromethyl); and a is two.

Particularly preferred compounds of formula (IA) include 5-cyclopropyl-4-(2-methylsulfonyl-4-trifluoromethyl)benzoylisoxazole (isoxaflutole) and 4-(2-chloro-4-methylsulphonyl)benzoyl-5-cyclopropylisoxazole (isoxachlortole), especially isoxaflutole.

Suitably, the triketone is a compound of formula (IB),

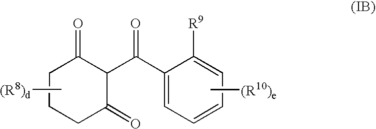

wherein each R⁸ independently represents (C₁₋₄)alkyl or —CO₂R¹¹;

R⁹ represents a halogen atom; a straight- or branched-chain alkyl or alkoxy group containing up to six carbon atoms which is optionally substituted by one or more groups —OR¹² or one or more halogen atoms; or a group selected from nitro, cyano, —CO₂R¹³, —S(O)_{f}R¹², —O(CH₂)_{g}OR¹², —COR¹³, —NR¹³R¹⁴, —SO₂NR¹³R¹⁴, —CONR¹³R¹⁴, —CSNR¹³R¹⁴ and —OSO₂R¹⁵;

each R¹⁰ independently represents halo, nitro, cyano, S(O)_{f}R¹⁶, OS(O)_{f}R¹⁶, C₁₋₆ alkyl, C₁₋₆ alkoxy, C₁₋₆ haloalkyl, C₁₋₆ haloalkoxy, carboxy, C₁₋₆ alkylcarbonyloxy, C₁₋₆ alkoxycarbonyl, C₁₋₆ alkylcarbonyl, amino, C₁₋₆ alkylamino, C₁₋₆ dialkylamino having independently the stated number of carbon atoms in each alkyl group, C₁₋₆ alkylcarbonylamino, C₁₋₆ alkoxycarbonylamino, C₁₋₆ alkylaminocarbonylamino, C₁₋₆ dialkylaminocarbonylamino having independently the stated number of carbon atoms in each alkyl group, C₁₋₆ alkoxycarbonyloxy, C₁₋₆ alkylaminocarbonyloxy, C₁₋₆ dialkylcarbonyloxy, phenylcarbonyl, substituted phenylcarbonyl, phenylcarbonyloxy, substituted phenylcarbonyloxy, phenylcarbonylamino, substituted phenylcarbonylamino, phenoxy or substituted phenoxy;

R¹¹ is C₁₋₄ alkyl;

R¹² represents a straight- or branched-chain alkyl group containing up to six carbon atoms which is optionally substituted by one or more halogen atoms;

R¹³ and R¹⁴ each independently represents a hydrogen atom; or a straight- or branched-chain alkyl group containing up to six carbon atoms which is optionally substituted by one or more halogen atoms;

R¹⁵ represents a straight- or branched-chain alkyl, alkenyl or alkynyl group containing up to six carbon atoms optionally substituted by one or more halogen atoms; or a cycloalkyl group containing from three to six carbon atoms;

R¹⁶ represents a straight or branched-chain alkyl group containing up to six carbon atoms;

d is zero or an integer from one to six;

e is zero or an integer from one to four;

f is zero, one or two; and

g is one, two or three;

with the exception of 2-(2′chloro-4′-methylsulphonylbenzoyl)-1,3-cyclohexanedione.

Suitably, R⁹ is chloro, bromo, nitro, cyano, C₁₋₄ alkyl, —CF₃, —S(O)_{f}R¹², or —OR¹²; each R¹⁰ is independently chloro, bromo, nitro, cyano, C₁₋₄ alkyl, —CF₃, —OR¹², —OS(O)_{f}R⁶ or —S(O)_{f}R⁶; d is zero and e is one or two.

Preferred compounds of formula (IB) are 2-(2′-nitro-4′-methylsulphonylbenzoyl)-1,3-cyclohexanedione (mesotrione), 2-(2′-nitro-4′-methylsulphonyloxybenzoyl)-1,3-cyclohexanedione, 4,4-dimethyl-2-(4-methanesulphonyl-2-nitrobenzoyl)-1,3-cyclohexanedione, 2-(2-chloro-3-ethoxy-4-methanesulphonylbenzoyl)-5-methyl-1,3-cyclohexanedione and 2-(2-chloro-3-ethoxy-4-ethanesulphonylbenzoyl)-5-methyl-1,3-cyclohexanedione; most preferably is 2-(2′-nitro-4′-methylsulphonyl benzoyl)-1,3-cyclohexanedione.

The compounds of formula (IB) may exist in enolic tautomeric forms that may give rise to geometric isomers. Furthermore, in certain cases, the various substituents may contribute to optical isomerism and/or stereoisomerism. All such tautomeric forms, racemic mixtures and isomers are included within the scope of the present invention.

Alternatively, the triketone is a compound of formula (IC)

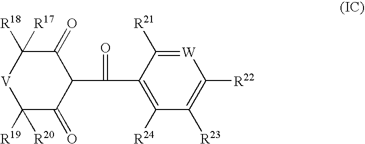

wherein V is C₁₋₂ alkylene, which may be mono- or poly-substituted by R²⁶; or, when R¹⁸ and R¹⁹ are other than C₂₋₃ alkylene, V may additionally be carbonyl, oxygen or —NR²⁷—;

W is CR²⁸ or N(O)_{g};

R¹⁷, R¹⁸, R¹⁹ and R²⁰ are independently hydrogen, C₁₋₄ alkyl, phenyl, C₁₋₄ alkoxy, halogen, hydroxy, cyano, hydroxycarbonyl or C₁₋₄ alkoxycarbonyl; or R¹⁸ and R¹⁹ together are C₂₋₃ alkylene, which may be mono- or poly-substituted by R²⁵;

R²¹ is hydrogen, C₁₋₆ alkyl, C₁₋₆ haloalkyl, C₂₋₆ alkenyl, C₂₋₆ haloalkenyl, C₁₋₂ alkoxycarbonyl- or phenyl-substituted vinyl, C₂₋₆ alkynyl, C₂₋₆ haloalkynyl, trimethylsilyl-, hydroxy-, C₁₋₆ alkoxy-, C alkoxycarbonyl- or phenyl-substituted ethynyl, C₃₋₆ allenyl, C₃₋₆ cycloalkyl, halo- or C₁₋₃ alkoxymethyl-substituted C₃₋₆ cycloalkyl, C₁₋₆-alkoxy, C₃₋₆ alkenyloxy, C₃₋₆ alkynyloxy, C₁₋₆ haloalkoxy, C₃₋₆ haloalkenyloxy, cyano-C₁₋₄ alkoxy, C₁₋₄ alkoxy-C₁₋₄ alkoxy, C₁₋₄ alkylthio-C₁₋₄ alkoxy, C₁₋₄ alkylsulfinyl-C₁₋₄-alkoxy, C₁₋₄ alkylsulfonyl-C₁₋₄ alkoxy, C₁₋₄ alkoxycarbonyl-C₁₋₄ alkoxy, C₁₋₆ alkylthio, C₁₋₆ alkylsulfinyl, C₁₋₆ alkylsulfonyl, C₁₋₆ haloalkylthio, C₁₋₆ haloalkylsulfinyl, C₁₋₆ halo-alkylsulfonyl, C₁₋₄ alkoxycarbonyl-C₁₋₄ alkylthio, C₁₋₄ alkoxycarbonyl-C₁₋₄ alkylsulfinyl, C₁₋₄ alkoxycarbonyl-C₁₋₄ alkylsulfonyl, C₁₋₆ alkylamino, di(C₁₋₆ alkyl)amino, C₁₋₃ alkoxy-C₁₋₃ alkylamino, C₁₋₃ alkoxy-C₁₋₃ alkyl-N(C₁₋₃ alkyl), C₁₋₆ alkylaminosulfonyl, di(C₁₋₆-alkyl)aminosulfonyl, C₁₋₄ alkylsulfonyloxy, C₁₋₄ haloalkylsulfonyloxy, C₁₋₄ alkylsulfonyl-amino, C₁₋₄ alkylsulfonyl-N(C₁₋₄ alkyl), cyano, carbamoyl, C₁₋₄ alkoxycarbonyl, formyl, halogen, rhodano, amino, hydroxy-C₁₋₄ alkyl, C₁₋₄ alkoxy-C₁₋₄ alkyl, C₁₋₄ alkylthio-C₁₋₄-alkyl, C₁₋₄ alkylsulfinyl-C₁₋₄ alkyl, C₁₋₄ alkylsulfonyl-C₁₋₄ alkyl, cyano-C₁₋₄ alkyl, C₁₋₆-alkylcarbonyloxy-C₁₋₄ alkyl, C₁₋₄ alkoxycarbonyl-C₁₋₄ alkyl, C₁₋₄ alkoxycarbonyloxy-C₁₋₄-alkyl, rhodano-C₁₋₄ alkyl, phenyl-C₁₋₄ alkyl, phenoxy-C₁₋₄ alkyl, benzyloxy-C₁₋₄ alkyl, benzoyloxy-C₁₋₄ alkyl, (2-oxiranyl)-C₁₋₄ alkyl, C₁₋₄ alkylamino-C₁₋₄ alkyl, di(C₁₋₄ alkyl)-amino-C₁₋₄ alkyl, C₁₋₁₂ alkylthiocarbonyl-C₁₋₄ alkyl or formyl-C₁₋₄ alkyl, or benzylthio, benzylsulfinyl, benzylsulfonyl, benzyloxy, benzyl, phenyl, phenoxy, phenylthio, phenylsulfinyl or phenylsulfonyl, wherein the phenyl-containing groups may themselves be substituted by C₁₋₃ alkyl, C₁₋₃ haloalkyl, C₁₋₃ alkoxy, C₁₋₃ haloalkoxy, halogen, cyano or by nitro; or

R²¹ is a three- to ten-membered monocyclic or fused bicyclic ring system, which may be aromatic, saturated or partially saturated and may contain from 1 to 4 hetero atoms selected from nitrogen, oxygen and sulfur, wherein the ring system is bonded to the group W-containing aromatic ring by way of a C₁₋₄ alkylene, C₂₋₄ alkenylene or C₂₋₄ alkynylene bridge which may be interrupted by oxygen, —N(C₁₋₄ alkyl)-, sulfur, sulfinyl, sulfonyl or by carbonyl, and each ring system may contain no more than two oxygen atoms and no more than two sulfur atoms, and the ring system may itself be mono-, di- or tri-substituted by C₁₋₆ alkyl, C₁₋₆ haloalkyl, C₂₋₆ alkenyl, C₂₋₆ haloalkenyl, C₂₋₆ alkynyl, C₂₋₆ haloalkynyl, C₁₋₆ alkoxy, C₁₋₆ haloalkoxy, C₃₋₆ alkenyloxy, C₃₋₆ alkynyloxy, hydroxy, mercapto, C₁₋₆ alkylthio, C₁₋₆ haloalkylthio, C₃₋₆ alkenylthio, C₃₋₆ haloalkenylthio, C₃₋₆ alkynylthio, C₁₋₄ alkoxy-C₁₋₃ alkylthio, C₁₋₄ alkylcarbonyl-C₁₋₃ alkylthio, C₁₋₄ alkoxycarbonyl-C₁₋₃ alkylthio, cyano-C₁₋₃ alkylthio, C₁₋₆ alkylsulfinyl, C₁₋₆ haloalkylsulfinyl, C₁₋₆ alkylsulfonyl, C₁₋₆ haloalkylsulfonyl, aminosulfonyl, C₁₋₄ alkylaminosulfonyl, di(C₁₋₄ alkyl)aminosulfonyl, di(C₁₋₄ alkyl)amino, halogen, cyano, nitro, phenyl and/or by benzylthio, wherein phenyl and benzylthio may themselves be substituted on the phenyl ring by C₁₋₃ alkyl, C₁₋₃ haloalkyl, C₁₋₃ alkoxy, C₁₋₃ haloalkoxy, halogen, cyano or by nitro, and wherein substituents on the nitrogen in the heterocyclic ring are other than halogen; or

R²¹ is the group -D₁-D₃ or the group -D₂-D₁-D₃;

R²² is hydrogen, C₁₋₆ alkyl, C₁₋₆ haloalkyl, C₂₋₆ alkenyl, C₂₋₆ haloalkenyl, C₂₋₆ alkynyl, C₂₋₆ haloalkynyl, C₃₋₆ cycloalkyl, C₁₋₆ alkoxy, C₁₋₆ haloalkoxy, C₁₋₆ alkylthio, C₁₋₆ alkylsulfinyl, C₁₋₆ alkylsulfonyl, C₁₋₆ haloalkylthio, C₁₋₆ haloalkylsulfinyl, C₁₋₆ haloalkylsulfonyl, C₁₋₆ alkylsulfonyloxy, hydroxy, mercapto, amino, C₁₋₆ alkylamino, di(C₁₋₆ alkyl)amino, C₁₋₄ alkylsulfonylamino, C₁₋₄ alkylsulfonyl-N(C₁₋₄ alkyl)-, C₁₋₆ alkylaminosulfonyl, di(C₁₋₆ alkyl)aminosulfonyl, cyano, halogen, C₁₋₄ alkoxy-C₁₋₄ alkyl, C₁₋₄ alkylthio-C₁₋₄ alkyl, C₁₋₄ alkylsulfinyl-C₁₋₄ alkyl, C₁₋₄ alkylsulfonyl-C₁₋₄ alkyl, triazolyl, phenyl, phenylthio, phenylsulfinyl, phenylsulfonyl or phenoxy, wherein the phenyl-containing groups may be substituted by C₁₋₃ alkyl, C₁₋₃ haloalkyl, C₁₋₃ alkoxy, C₁₋₃ haloalkoxy, halogen, cyano or by nitro;

R²³ is hydrogen, C₁₋₆ alkyl, hydroxy, C₁₋₆ alkoxy, C₁₋₆ haloalkoxy, C₃₋₆ alkenyloxy, C₃₋₆ haloalkenyloxy, C₃₋₆ alkynyloxy, C₁₋₄ alkylcarbonyloxy, C₁₋₄ alkylsulfonyloxy, phenylsulfonyloxy, C₁₋₄ alkylthio, C₁₋₄ alkylsulfinyl, C₁₋₄ alkylsulfonyl, C₁₋₄ alkylamino, di(C₁₋₄ alkyl)amino, C₁₋₄ alkoxycarbonyl, C₁₋₄ haloalkyl, formyl, cyano, halogen, phenyl or phenoxy, wherein the phenyl-containing groups may themselves be substituted by C₁₋₃ alkyl, C₁₋₃ haloalkyl, C₁₋₃ alkoxy, C₁₋₃ haloalkoxy, halogen, cyano or by nitro; or

R²³ is a three- to ten-membered monocyclic or, together with R²⁵ or R²⁷, fused bicyclic ring system, which may contain from 1 to 4 hetero atoms selected from nitrogen, oxygen and sulfur, wherein, when the ring system is not fused, it is bonded to the W-containing aromatic ring, either directly or by way of a C₁₋₄ alkylene, C₂₋₄ alkenylene or C₂₋₄ alkynylene bridge which may be interrupted by oxygen, —N(C₁₋₄ alkyl)-, sulfur, sulfinyl, sulfonyl or by carbonyl, and the ring system may contain no more than two oxygen atoms and no more than two sulfur atoms, and the ring system may itself be mono-, di- or tri-substituted by C₁₋₆ alkyl, C₁₋₆ haloalkyl, C₂₋₆ alkenyl, C₂₋₆ haloalkenyl, C₂₋₆ alkynyl, C₂₋₆ haloalkynyl, C₁₋₆ alkoxy, C₁₋₆ haloalkoxy, C₃₋₆ alkenyloxy, C₃₋₆ alkynyloxy, C₁₋₆ alkylthio, C₁₋₆ haloalkylthio, C₃₋₆ alkenylthio, C₃₋₆haloalkenylthio, C₃₋₆ alkynylthio, C₁₋₄ alkoxy-C₁₋₂ alkylthio, C₁₋₄ alkylcarbonyl-C₁₋₂ alkylthio, C₁₋₄ alkoxycarbonyl-C₁₋₂ alkylthio, cyano-C₁₋₄ alkylthio, C₁₋₆ alkylsulfinyl, C₁₋₆ halo-alkylsulfinyl, C₁₋₆ alkylsulfonyl, C₁₋₆ haloalkylsulfonyl, aminosulfonyl, C₁₋₄ alkylamino-sulfonyl, di(C₁₋₄ alkyl)aminosulfonyl, amino, C₁₋₄ alkylamino, di(C₁₋₄ alkyl)amino, halogen, cyano, nitro, phenyl and by/or benzylthio, wherein phenyl and benzylthio may themselves be substituted on the phenyl ring by C₁₋₃ alkyl, C₁₋₃ haloalkyl, C₁₋₃ alkoxy, C₁₋₃ haloalkoxy, halogen, cyano or by nitro, and wherein substituents on the nitrogen in the heterocyclic ring are other than halogen;

R²⁴ is hydrogen, C₁₋₆ alkyl, C₁₋₆ haloalkyl, C₂₋₆ alkenyl, C₂₋₆ haloalkenyl, C₂₋₆ alkynyl, C₂₋₆ haloalkynyl, C₃₋₆ cycloalkyl, C₁₋₆ alkoxy, C₁₋₆ haloalkoxy, C₁₋₆ alkylthio, C₁₋₆ alkylsulfinyl, C₁₋₆ alkylsulfonyl, C₁₋₆ haloalkylthio, C₁₋₆ haloalkylsulfinyl, C₁₋₆ haloalkylsulfonyl, amino, C₁₋₆ alkylamino, di(C₁₋₆ alkyl)amino, C₁₋₄ alkylsulfonyl-N(C₁₋₄ alkyl)-, C₁₋₆ alkylaminosulfonyl, di(C₁₋₆ alkyl)aminosulfonyl, cyano, halogen, C₁₋₄ alkoxy-C₁₋₄ alkyl, C₁₋₄ alkylthio-C₁₋₄ alkyl, C₁₋₄ alkylsulfinyl-C₁₋₄ alkyl, C₁₋₄ alkylsulfonyl-C₁₋₄ alkyl, phenyl, phenylthio, phenylsulfinyl, phenylsulfonyl or phenoxy, wherein phenyl groups may themselves be substituted by C₁₋₃ alkyl, C₁₋₃ haloalkyl, C₁₋₃ alkoxy, C₁₋₃ haloalkoxy, halogen, cyano or by nitro;

R²⁵ and R²⁶ are each independently hydrogen, C₁₋₄ alkyl, phenyl, C₁₋₄ alkoxy, halogen, hydroxy, cyano, hydroxycarbonyl or C₁₋₄ alkoxycarbonyl;

R²⁷ is C₁₋₄ alkyl, alkoxycarbonyl or C₁₋₄ alkylcarbonyl;

R²⁸ is hydrogen, C₁₋₆ alkyl, hydroxy, C₁₋₆ alkoxy, C₁₋₆haloalkoxy, C₃₋₆ alkenyloxy, C₃₋₆ haloalkenyloxy, C₃₋₆ alkynyloxy, C₁₋₄ alkylcarbonyloxy, C₁₋₄ alkylsulfonyloxy, phenylsulfonyloxy, C₁₋₆ alkylthio, C₁₋₆ alkylsulfinyl, C₁₋₆ alkylsulfonyl, C₁₋₆ alkylamino, di(C₁₋₆ alkyl)amino, C₁₋₃ alkoxy-C₁₋₃ alkylamino, C₁₋₃ alkoxy-C₁₋₃ alkyl-N(C₁₋₃ alkyl)-, C₁₋₄ alkoxycarbonyl, C₁₋₆ haloalkyl, formyl, cyano, halogen, phenyl or phenoxy, wherein the phenyl-containing groups may themselves be substituted by C₁₋₃ alkyl, C₁₋₃ haloalkyl, C₁₋₃ alkoxy, C₁₋₃ haloalkoxy, halogen, cyano or by nitro;

or R²⁸ is a three- to ten-membered monocyclic or, together with R²¹ or R²² fused bicyclic ring system, which may be interrupted once or up to three times by heterocyclic substituents selected from oxygen, sulfur, S(O), SO₂, N(R²⁹), carbonyl and C(—NOR³⁰), and wherein, when the ring system is not fused, it is bonded to the carbon atom of the substituent W, either directly or by way of a C₁₋₄ alkylene, C₂₋₄ alkenylene or C₂₋₄ alkynylene bridge which may be interrupted by oxygen, —N(C₁₋₄ alkyl)-, sulfur, sulfinyl or by sulfonyl, and the ring system may contain no more than two oxygen atoms and no more than two sulfur atoms, and the ring system may itself be mono-, di- or tri-substituted by C₁₋₆ alkyl, C₁₋₆haloalkyl, C₂₋₆ alkenyl, C₂₋₆ haloalkenyl, C₂₋₆ alkynyl, C₂₋₆ haloalkynyl, C₁₋₆ alkoxy, C₁₋₆ haloalkoxy, C₃₋₆ alkenyloxy, C₃₋₆ alkynyloxy, C₁₋₆ alkylthio, C₁₋₆ haloalkylthio, C₃₋₆ alkenylthio, C₃₋₆ haloalkenylthio, C₃₋₆ alkynylthio, C₁₋₄ alkoxy-C₁₋₂ alkylthio, C₁₋₄ alkylcarbonyl-C₁₋₂ alkylthio, C₁₋₄ alkoxycarbonyl-C₁₋₂ alkylthio, cyano-C₁₄ alkylthio, C₁₋₆ alkylsulfinyl, C₁₋₆ haloalkylsulfinyl, C₁₋₆ alkylsulfonyl, C₁₋₆ haloalkylsulfonyl, aminosulfonyl, C₁₋₄ alkylaminosulfonyl, di(C₁₋₄ alkyl)aminosulfonyl, di(C₁₋₄ alkyl)amino, halogen, cyano, nitro, phenyl, benzyloxy and/or by benzylthio, and wherein the phenyl-containing gro'ups may themselves be substituted on the phenyl ring by C₁₋₃ alkyl, C₁₋₃ haloalkyl, C₁₋₃ alkoxy, C₁₋₃ haloalkoxy, halogen, cyano or by nitro, and wherein substituents on the nitrogen in the heterocyclic ring are other than halogen;

or R¹⁸ is the group -D₄-D₆ or the group -D₅-D₄-D₆;

R²⁹ is hydrogen, C₁₋₄ alkyl, C₁₋₄ alkylthio-C₁₋₄ alkylcarbonyl, C₁₋₄ alkylsulfinyl-C₁₋₄ alkylcarbonyl, C₁₋₄ alkylsulfonyl-C₁₋₄ alkylcarbonyl, C₁₋₄ alkoxycarbonyl, C₁₋₄ alkyl-carbonyl, phenylcarbonyl or phenyl, wherein the phenyl groups may themselves be substituted by C₁₋₄ alkyl, C₁₋₄ haloalkyl, C₁₋₄ alkoxy, C₁₋₄ haloalkoxy, C₁₋₄ alkylcarbonyl, C₁₋₄ alkoxycarbonyl, C₁₋₄ alkylamino, di(C₁₋₄ alkyl)amino, C₁₋₄ alkylthio, C₁₋₄ alkylsulfinyl, C₁₋₄ alkyl-SO₂, C₁₋₄ alkyl-S(O)₂O, C₁₋₄ haloalkylthio, C₁₋₄haloalkylsullinyl, C₁₋₄ haloalkyl-SO₂, C₁₋₄ haloalkyl-S(O)₂O, C₁₋₄ alkyl-S(O)₂NH, C₁₋₄ alkyl-S(O)₂N(C₁₋₄ alkyl)-, halogen, nitro or by cyano;

R³⁰ is hydrogen, C₁₋₄ alkyl, C₃₋₄ alkenyl, C₃₋₄ alkynyl or benzyl;

h is 0 or 1;

D₁ is oxygen, —O(CO)—, —(CO)O—, —O(CO)O—, —N(C₁₋₄ alkyl)-O—, —O—N(C₁₋₄ alkyl)-, thio, sulfinyl, sulfonyl, —SO₂N(C₁₋₄ alkyl)-, —N(C₁₋₄ alkyl)SO₂—, —N(C₁₋₂ alkoxy-C₁₋₂ alkyl)SO₂— or —N(C₁₋₄ alkyl)-;

D₂ is a C₁₋₆ alkylene, C₃₋₆ alkenylene or C₃₋₆ alkynylene chain, which may be mono- or poly-substituted by halogen or by D₇, the unsaturated bonds of the chain not being bonded directly to the substituent D₁;

D₃ and D₆ are each independently of the other a C₁₋₈ alkyl, C₃₋₆ alkenyl or C₃₋₆ alkynyl group, which may be mono- or poly-substituted by halogen, hydroxy, amino, formyl, nitro, cyano, mercapto, carbamoyl, C₁₋₆ alkoxy, C₁₋₆ alkoxycarbonyl, C₂₋₆ alkenyl, C₂₋₆ haloalkenyl, C₂₋₆ alkynyl, C₂₋₆ haloalkynyl, C₃₋₆ cycloalkyl, halo-substituted C₃₋₆ cycloalkyl, C₃₋₆ alkenyloxy, C₃₋₆ alkynyloxy, C₁₋₆ haloalkoxy, C₃₋₆ haloalkenyloxy, cyano-C₁₋₆ alkoxy, C₁₋₆ alkoxy-C₁₋₆ alkoxy, C₁₋₆ alkoxy-C₁₋₆ alkoxy-C₁₋₆ alkoxy, C₁₋₆ alkylthio-C₁₋₆ alkoxy, C₁₋₆ alkylsulfinyl-C₁₋₆ alkoxy, C₁₋₆ alkylsulfonyl-C₁₋₆ alkoxy, C₁₋₆ alkoxy-carbonyl-C₁₋₆ alkoxy, C₁₋₆ alkoxycarbonyl, C₁₋₆ alkylcarbonyl, C₁₋₆ alkylthio, C₁₋₆ alkyl-sulfinyl, C₁₋₆ alkylsulfonyl, C₁₋₆ haloalkylthio, C₁₋₆ haloalkylsulfinyl, C₁₋₆ haloalkyl-sulfonyl, oxiranyl which may itself be substituted by C₁₋₆ alkyl, (3-oxetanyl)-oxy which may itself be substituted by C₁₋₆ alkyl, benzyloxy, benzylthio, benzylsulfinyl, benzylsulfonyl, C₁₋₆ alkylamino, di(C₁₋₆ alkyl)amino, C₁₋₄ alkyl-S(O)₂O, di(C₁₋₄ alkyl)aminosulfonyl, rhodano, phenyl, phenoxy, phenylthio, phenylsulfinyl or by phenylsulfonyl, and wherein the phenyl- or benzyl-containing groups may themselves be substituted by one or more C₁₋₆ alkyl, C₁₋₆ haloalkyl, C₁₋₆ alkoxy, C₁₋₆ haloalkoxy, halogen, cyano, hydroxy or nitro groups; or

D₃ and D₆ are each independently of the other phenyl, which may be mono- or poly-substituted by C₁₋₆ alkyl, C₁₋₆ haloalkyl, C₁₋₆ alkoxy, C₁₋₆ haloalkoxy, halogen, cyano, hydroxy or by nitro; or

D₃ and D₆ are each independently of the other C₃₋₆ cycloalkyl, C₁₋₆ alkoxy- or C₁₋₆ alkyl-substituted C₃₋₆ cycloalkyl, 3-oxetanyl or C₁₋₆ alkyl-substituted 3-oxetanyl; or

D₃ and D₆ are each independently of the other a three- to ten-membered monocyclic or fused bicyclic ring system, which may be aromatic, saturated or partially saturated and may contain from 1 to 4 hetero atoms selected from nitrogen, oxygen and sulfur, wherein the ring system is bonded to the substituent D₁ or D₄ directly or by way of a C₁₋₄ alkylene, C₂₋₄ alkenylene, C₂₋₄ alkynylene, —N(C₁₋₄ alkyl)-C₁₋₄ alkylene, —S(O)—C₁₋₄ alkylene or —SO₂—C₁₋₄ alkylene group, and each ring system may contain no more than two oxygen atoms and no more than two sulfur atoms, and the ring system may itself be mono-, di- or tri-substituted by C₁₋₆ alkyl, C₁₋₆ haloalkyl, C₂₋₆ alkenyl, C₂₋₆ haloalkenyl, C₂₋₆ alkynyl, C₂₋₆ haloalkynyl, C₁₋₆ alkoxy, hydroxy, C₁₋₆ haloalkoxy, C₃₋₆ alkenyloxy, C₃₋₆ alkynyloxy, mercapto, C₁₋₆ alkylthio, C₁₋₆ haloalkllthiio, C₃₋₆ alkenylthio, C₃₋₆ haloalkenylthio, C₃₋₆ alkynylthio, C₁₋₃ alkoxy-C₁₋₃ alkylthio, C₁₋₄ alkylcarbonyl-C₁₋₂ alkylthio, C₁₋₄ alkoxycarbonyl-C₁₋₂ alkylthio, cyano-C₁₋₃ alkylthio, C₁₋₆ alkylsulfinyl, C₁₋₆ haloalkylsulfinyl, C₁₋₆ alkylsulfonyl, C₁₋₆ haloalkylsulfonyl, aminosulfonyl, C₁₋₂ alkylaminosulfonyl, di(C₁₋₂ alkyl)aminosulfonyl, di(C₁₋₄ alkyl)amino, C₁₋₆ carbonylamino, halogen, cyano, nitro, phenyl, benzyloxy and/or by benzylthio, wherein the phenyl groups may themselves be substituted on the phenyl ring by C₁₋₃ alkyl, C₁₋₃ haloalkyl, C₁₋₃ alkoxy, C₁₋₃ haloalkoxy, halogen, cyano or by nitro, and wherein the substituents on the nitrogen in the heterocyclic ring are other than halogen;

D₄ is oxygen, —O(CO)—, —(CO)O—, —O(CO)O—, —N(C₁₋₄ alkyl)-O—, —O—N(C₁₋₄ alkyl)-, sulfur, sulfinyl, sulfonyl, —SO₂N(C₁₋₄ alkyl)-, —N(C₁₋₄ alkyl)SO₂—, —N(C₁₋₂ alkoxy-C₁₋₂ alkyl)SO₂— or —N(C₁₋₄ alkyl)-;

D₅ is a C₁₋₆ alkylene, C₃₋₆ alkenylene or C₃₋₆ alkynylene chain, which may be mono- or poly-substituted by halogen or by D8, the unsaturated bonds of the chain not being bonded directly to the substituent D₄;

D₇ and D8 are each independently of the other hydroxy, C₁₋₆ alkoxy, (C₃₋₆ cycloalkyl)oxy, C₁₋₆ alkoxy-C₁₋₆ alkoxy, C₁₋₆ alkoxy-C₁₋₆ alkoxy-C₁₋₆ alkoxy or C₁₋₆ alkylsulfonyloxy;

and agronomically acceptable salts/N-oxides/isomers/enantiomers of such compounds.

Alternatively, the triketone may be present in an enolic form and is a compound of formula (ID)

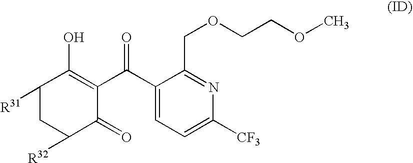

wherein R³¹ and R³² are both hydrogen or together form an ethylene bridge.

The compound of formula (ID) wherein both R³¹ and R³² are hydrogen is hereinafter referred to as compound (IDa), and the compound of formula (ID) wherein R³¹ and R³² together form an ethylene bridge is hereinafter referred to as compound (IDb).

Suitably, the pyrazole is a compound of formula (IE)

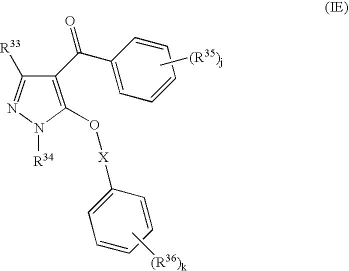

wherein R³³, R³⁴, R³⁵ and R³⁶ are each independently selected from hydrogen, halo or C₁₋₄ alkyl;

X is —SO₂— or —CH₂CO—;

j is 2 or 3; and

k is zero or 1.

Suitably R³³, R³⁴, R³⁵ and R³⁶ are each independently hydrogen, chloro or methyl.

Preferred compounds of formula (IE) include 2-[[4-(2,4-dichloro-3-methylbenzoyl)-1,3-dimethyl-1H-pyrazol-5-yl]oxy]-1-(4-methylphenyl)ethanone (benzofenap), (2,4-dichlorophenyl)[1,3-dimethyl-5-[[(4-methylphenyl)sulfonyl]oxy]-1H-pyrazol-4-yl]methanone (pyrazolynate) and 2-[[4-(2,4-dichlorobenzoyl)-1,3-dimethyl-1H-pyrazol-5-yl]oxy]-1-phenylethanone (pyrazoxyfen).

Alternatively, the pyrazole is a compound of formula (IF)

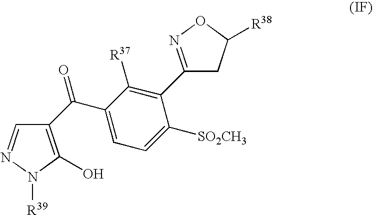

wherein R³⁷ is C₁₋₂ alkyl or chloro; R³⁸ is hydrogen or C₁₋₄ alkyl; and R³⁹ is C₁₋₄ alkyl.

Benzobicyclon is a compound of formula (IG)

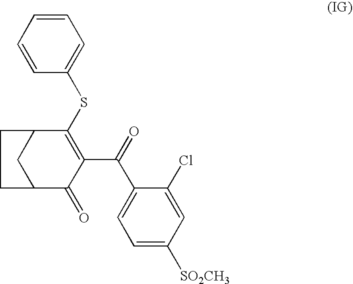

Ketospiradox is a compound of formula (IH)

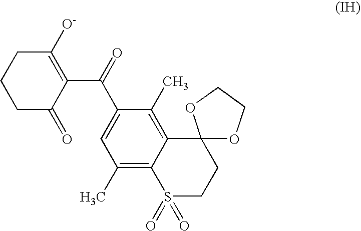

In one embodiment of the invention, the HPPD inhibitor is selected from the group consisting of benzobicyclon, benzofenap, isoxaflutole, mesotrione, pyrazolynate and pyrazoxyfen.

In a further embodiment, the EPPD inhibitor is mesotrione.

In another embodiment, the HPPD inhibitor is isoxaflutole.

By the term ‘electrolyte’, we mean a substance that, when dissolved in water, dissociates to ionic species. For example, the electrolyte may be selected from the group consisting of:

(a) a simple ionic compound, such as ammonium sulphate or sodium chloride; or

(b) an additional active ingredient, such as glyphosate, paraquat or diquat. The glyphosate is suitably in the form of a salt. A wide variety of glyphosate salts are known, including sodium, potassium, ammonium, and various amines, such as the isopropylamine, ethanolamine, diethanolamine and triethylamine salts. The potassium, ammonium and ethanolamine salts are preferred, particularly the potassium and ammonium salts.

Suitably, the ratio of HPPD inhibitor:electrolyte in the concentrate formulation is from 70:1 to 1:5 and preferably from 35:1 to 1:1.

Suitably, the concentrate comprises from 10 to 600 g/l of HPPD inhibitor, preferably 10 to 100 g/l.

Suitably, the concentrate comprises from 10 to 700 g/l of electrolyte, and preferably from 50 to 400 g/l.

In addition to the HPPD inhibitor and electrolyte, a number of adjuvants may be included in the aqueous pre-mix concentrate formulation. These may include, but are not restricted to, suspending agents, surfactants, buffers, stabilisers and biocides. Adjuvants may be included in the concentrate of the invention to enhance the efficacy of the mesotrione and/or electrolyte. A broad range of surface-active agents are advantageously employed in liquid compositions, especially those designed to be diluted with carrier before application. The surface-active agents can be anionic, cationic, nonionic or polymeric in character and can be employed as emulsifying agents, wetting agents, suspending agents, or for other purposes. Typical surface active agents include salts of alkyl sulfates, such as diethanolammonium lauryl sulfate; alkylarylsulfonate salts, such as calcium dodecylbenzenesulfonate; alkylphenol-alkylene oxide addition products, such as nonylphenol-C.sub.18 ethoxylate; alcohol-alkylene oxide addition products, such as tridecyl alcohol-C.sub.16 ethoxylate; soaps, such as sodium stearate; alkylnaphthalenesulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; alkyl polyglycoside; quaternary amines, such as lauryl trimethylammonium chloride; polyethylene glycol esters of fatty acids, such as polyethylene glycol stearate; block copolymers of ethylene oxide and propylene oxide; and salts of mono and dialkyl phosphate esters.

Other adjuvants commonly utilized in agricultural compositions include crystallization inhibitors, viscosity modifiers, suspending agents, spray droplet modifiers, pigments, antioxidants, foaming agents, light-blocking agents, compatibilizing agents, antifoam agents, sequestering agents, neutralizing agents and buffers, corrosion inhibitors, dyes, odorants, spreading agents, penetration aids, micronutrients, emolients, lubricants, sticking agents, dispersing agents, thickening agents, freezing point depressants, antimicrobial agents, and the like. The compositions can also contain other compatible components, for example, other herbicides, herbicide safeners, plant growth regulants, fungicides, insecticides, and the like and can be formulated with liquid fertilizers or solid, particulate fertilizer carriers such as ammonium nitrate, urea and the like.

The aqueous pre-mix concentrate formulation of the invention can be made by preparing a HPPD inhibitor mill base and then adding the millbase and electrolyte, plus any additional adjuvants required, to water. Accordingly, a further aspect of the invention provides a process for the preparation of an aqueous pre-mix concentrate formulation of the invention, said process comprising the steps of:

(i) separately preparing a HPPD inhibitor millbase and an electrolyte solution, and

(ii) adding the HPPD inhibitor millbase and the electrolyte solution to water.

The aqueous pre-mix concentrate formulation of the invention may be used for the control of unwanted vegetation, particularly unwanted vegetation in a field of useful crops, such as maize, soybean, cereals, rape, sugar beet, sugar cane, plantation crops, rice and cotton. Suitably the crop is maize or soybean and preferably maize.

Crops are to be understood as including those crop which have been made tolerant to one or more herbicides or one or more classes of herbicide by conventional methods of breeding or gene technology.

Before use, the aqueous pre-mix concentrate formulation of the present invention is suitably first diluted, preferably with water, by between 2 and 500 times. Accordingly, a still further aspect of the invention provides a ready-to-use aqueous composition comprising:

(i) water,

(ii) HPPD inhibitor, in suspension in the water, and

(iii) electrolyte, in solution in the water, in which the HPPD inhibitor is present in an amount of 0.2 to 12 g/l and the electrolyte is present in an amount of 0.01 to 50 g/l.

A yet further aspect of the invention provides a process for the control of unwanted vegetation, in particular unwanted vegetation in a field of useful crops, said process comprising the dilution of an aqueous pre-mix concentrate formulation of the invention to form a ready-to-use aqueous formulation, followed by the application of a herbicidally effective amount of said ready-to-use aqueous formulation to the locus of the unwanted vegetation.

A ‘herbicidally effective amount’ is the quantity of the ready-to-use formulation, which is capable of producing a controlling or modifying effect on the growth of plants. Typical application rates are 50 to 1500 g HPPD inhibitor+electrolyte/hectare, preferably 100 to 1250 g HPPD inhibitor+electrclyte/hectare.

Controlling or modifying effects include all deviation from natural development, for example, non-germination of seeds, plant death, retardation or growth, leaf burn, albinism, dwarfing and the like.

‘Locus’ means any part of the plants themselves, their seeds, or the ground or other medium where such plants might germinate or grow.

The ready-to-use aqueous composition may be applied by any of the usual application methods known in agriculture, most preferably by spraying.

As mentioned hereinbefore, we have discovered that it is the addition of an electrolyte to an aqueous concentrate formulation comprising an HPPD inhibitor that results in an improvement in the stability of the HPPD inhibitor, i.e. the HPPD inhibitor does not degrade as rapidly and therefore an aqueous concentrate formulation of the IPPD inhibitor can be stored for longer and/or under more severe conditions. Accordingly, a yet further aspect of the invention provides a process for improving the stability of an HPPD inhibitor in an aqueous concentrate formulation, said process comprising the addition of a HPPD inhibitor-stabilising amount of an electrolyte to said aqueous formulation. By “HPPD inhibitor-stabilising amount” we mean an amount of electrolyte that will give a stabilising effect, for example from 10 to 700 g/l.

The present invention will now be illustrated by means of the following non-limiting examples:

### COMPARATIVE EXAMPLE

A 35% w/w mesotrione acid millbase was prepared, which also contained, Tween 20 (2.1% w/w), Phosphoric acid (1.9% w/w), Atlox 4913 (1.1% w/w) and tap water (to 100% w/w). This millbase was prepared using mesotrione technical (approx 80% wet paste). A typical high shear mixer and then a “bead nnill” were used to mix and comminute the millbase to give an approximate mean D(4,3) particle size of 2-3 microns.

The final suspension was then prepared by combining the millbase, water and pre-prepared/pre-swollen kelzan gel (2%) (containing Proxel GXL) (0.375 g/l).

| Constituent Name | g/L | |
|---|---|---|
| Mesotrione (as acid) | 12 | |
| Tween 20 | 0.5 | |
| Atlox 4913 | 0.2 | |
| Phosphoric Acid | 0.05 | |
| Xanthan gum | 5.0 | |
| Proxel GXL | 0.375 | |
| Water | To 1 | litre |

### Example 1

A 35% w/w mesotrione acid millbase was prepared, which also contained, Tween 20 (2.1% w/w), Phosphoric acid (1.9% w/w), Atlox 4913 (1.1% w/w), and tap water (to 100% w/w). This millbase was prepared using mesotrione technical (approx 80% wet paste). A high shear mixer and then a bead mill were used to mix and comminute the millbase to give an approximate mean D(4,3) particle size of 2-3 microns.

The final suspension (360 g/L glyphosate, 12 g/L mesotrione) was then prepared by combining the millbase, glyphosate (using 46% w/w glyphosate acid equivalent as its potassium salt), pre-prepared/pre-swollen kelzan gel (containing Proxel GXL) and finally water. Simple mixing sufficed to give a homogeneous preparation, which can be summaried as follows:

| Constituent Name | g/L | |
|---|---|---|
| Glyphosate (as Potassium) | 360 | |
| Potassium hydroxide 100% | 134 | |
| Mesotrione (as acid) | 12 | |
| Tween 20 | 0.5 | |
| Atlox 4913 | 0.2 | |
| Phosphoric Acid | 0.05 | |
| Xanthan gum | 5.0 | |
| Proxel GXL | 0.375 | |
| Water | To 1 | litre |

### Example 2

This was prepared as in Example 1, with AL2575 (171.43 g/l) also being added, just after the glyphosate, when preparing the final product. In summary, the final preparation can be described as follows:

| Constituent Name | g/L | |
|---|---|---|
| Glyphosate (acid equivalent) | 360 | |
| Potassium hydroxide 100% | 134 | |
| Mesotrione acid | 12 | |
| Tween 20 | 0.5 | |
| Atlox 4913 | 0.2 | |
| Phosphoric acid | 0.05 | |
| AL2575 | 171.43 | |
| Xanthan gum | 5.0 | |
| Proxel GXL | 0.375 | |
| Water | To 1 | litre |

Results

Both products were tested for the chemical stability of the mesotrione in the formulation. Products were stored at 40° C. to give accelerated storage data (8 weeks at 40° C. is generally taken to correlate to two years at ambient temperature). The results are given in Table 1.

TABLE 1

| Example | Initial % | 2 weeks % | 8 weeks % | Loss |
|---|---|---|---|---|
| Comparative | 0.9651 | <0.1 | <0.1 | >90% |
| Example | | | | |
| Example 1 | 0.9676 | 0.9436 | 0.9105 | 5.90% |
| Example 2 | 0.9425 | 0.9319 | 0.7700 | 18.3% |

### Example 3

Eight aqueous millbase formulations were made comprising mesotrione millbase (12 g/L or 10,000 approximately) and varying amounts of glyphosate-potassium, ammonium sulphate, and sodium chloride. All samples were held at a pH of approximately 5 by using phosphoric acid for adjustment. The amount of mesotrione in solution was determined using UV-visible spectrophotometry, since the aqueous solubility of mesotrione is related to the expected rate of decomposition of this active ingredient in such systems. The results are shown in Table 2.

TABLE 2

| | Weight of | |
|---|---|---|
| | electrolyte in | Concentration of |
| | grams per litre of | mesotrione in solution |
| Aqueous Electrolyte | formulation | (ppm) |
| None | | 4700 |
| Potassium glyphosate | 100 | 1220 |
| | 200 | 700 |
| | 300 | 480 |
| | 360 | 290 |
| | 400 | 210 |
| | 500 | 180 |
| | 600 | 170 |
| | 640 | 160 |
| Ammonium sulphate solution | 100 | 625 |
| | 200 | 504 |
| | 300 | 391 |
| | 400 | 271 |
| | 500 | 263 |
| Sodium Chloride | 50 | 605 |
| | 105 | 549 |
| | 165 | 510 |
| | 230 | 479 |
| | 300 | 443 |

Table 2 clearly shows that the electrolyte has a strong effect on reducing the amount of dissolved mesotrione in the aqueous solution surrounding the mesotrione particles and backs up the Examples (1 and 2) as regards to reduction in chemical decomposition of mesotrione.

### Example 4

Millbase preparations of mesotrione and isoxaflutole were made using the following method:

The sample is placed in a round bottomed flask (˜140 mls) and mixed at 150 rpm for 15 minutes until homogeneous. An equal volume of glass beads is added to the flask (0.8-1.0 mm diameter) and the sample is milled at 650 rpm of 60 minutes. The particle size was checked. Further milling of the sample continued (60 minutes for mesotrione and 150 minutes for isoxaflutole). The particle size was checked again and all particles met the specification of 5 microns (D(4,3) volume weighted mean diameter).

The samples were extracted under vacuum through a sieve to disengage the beads from the millbases. The two millbases shown below were checked for AI content and used in the preparation of the salt mixtures. The final mixtures (see below) were then placed on storage at −18° C. (controlled initial sample) and +45° C. for 8 weeks. Analysis was then carried out using validated methods. The salts used were: glyphosate potassium aqueous solution; diquat dibromide aqueous solution; paraquat dichloride aqueous solution.

| | Mass/grams | Actual | % w/w |
|---|---|---|---|
| Mesotrione | 59.47 | 49.54 | 35.22 |
| Tween 20 | 2.92 | 2.92 | 2.08 |
| Atlox 4913 | 0.47 | 0.16 | 0.11 |
| Water | 77.79 | 77.79 | 55.31 |
| Isoxaflutole | 49.00 | 49.00 | 34.84 |
| Atlox 4894 | 0.98 | 0.98 | 0.70 |
| Atlox 4913 | 25.96 | 8.57 | 6.09 |
| Water | 64.08 | 64.08 | 45.56 |

Analytical Results: storage time was 8 weeks; sample denoted as “start” was held at −18° C. for the same period.

1% mesotrione and glyphosate pH ~5

| | | | | | | % | | | % |
|---|---|---|---|---|---|---|---|---|---|
| | Start | 45° C. | % decomposition | Start | 45° C. | decomposition | Start | 45° C. | decomposition |
| Mesotrione | 0.94 | 0.80 | 14.9 | | | | 1.05 | 0.86 | 18.1 |

| | | |
|---|---|---|
| Salt %: 45.00 (as glyphosate acid equivalent) | 30.00 (as glyphosate acid | 15.00 (as glyphosate acid |
| | equivalent) | equivalent) |

1% mesotrione and diquat pH ~4

| | | | | | | % | | | % |
|---|---|---|---|---|---|---|---|---|---|
| | Start | 45° C. | % decomposition | Start | 45° C. | decomposition | Start | 45° C. | decomposition |
| Mesotrione | 1.09 | 0.86 | 21.10 | 1.07 | 0.93 | 13.08 | 1.06 | 0.96 | 9.43 |

| | | |
|---|---|---|
| Salt %: 22.50 (as diquat anion) | 15.00 (as diquat anion) | 7.50 (as diquat anion) |

1% mesotrione and paraquat pH ~4

| | | | | | | % | | | % |
|---|---|---|---|---|---|---|---|---|---|
| | Start | 45° C. | % decomposition | Start | 45° C. | decomposition | Start | 45° C. | decomposition |
| Mesotrione | 1.10 | 0.90 | 18.18 | 1.12 | 0.98 | 12.50 | 1.10 | 0.96 | 12.73 |

| | | |
|---|---|---|
| Salt %: 30.00 (as paraquat anion) | 20.00 (as paraquat anion) | 10.00 (as paraquat anion) |

1% mesotrione adjusted pH 2 (using phosphoric acid)

| | Start | 45° C. | % decomposition | pH ~2 |
|---|---|---|---|---|
| Mesotrione | 1.07 | 0.96 | 10.28 | |

1% mesotrione not adjusted pH 5

| | Start | 45° C. | % decomposition | pH ~4.5 |
|---|---|---|---|---|
| Mesotrione | 1.27 | 0.83 | 34.65 | |

1% isoxaflutole and diquat pH ~4

| | | | | | | % | | | % |
|---|---|---|---|---|---|---|---|---|---|
| | Start | 45° C. | % decomposition | Start | 45° C. | decomposition | Start | 45° C. | decomposition |
| Isoxaflutole | 1.04 | 0.87 | 16.50 | 1.04 | 0.94 | 9.50 | 1.06 | 0.94 | 11.30 |

| | | |
|---|---|---|
| Salt %: 22.50 (as diquat anion) | 15.00 (as diquat anion) | 7.50 (as diquat anion) |

1% isoxaflutole and paraquat pH ~4

| | | | | | | % | | | % |
|---|---|---|---|---|---|---|---|---|---|
| | Start | 45° C. | % decomposition | Start | 45° C. | decomposition | Start | 45° C. | decomposition |
| Isoxaflutole | 0.86 | 0.80 | 7.00 | 1.02 | 0.90 | 12.00 | 1.05 | 0.99 | 6.00 |

| | | |
|---|---|---|
| Salt %: 30.00 (as paraquat anion) | 20.00 (as paraquat anion) | 10.00 (as paraquat anion) |

1% isoxaflutole unadjusted pH 7.0

| | | | % |
|---|---|---|---|
| | Start | 45° C. | decomposition |
| Isoxaflutole | 1.06 | 0.85 | 17.00 |

1% isoxaflutole adjusted pH 2.0

| | | | % |
|---|---|---|---|
| | Start | 45° C. | decomposition |
| Isoxaflutole | 0.98 | 1.02 | nil |

1. A chemically stable aqueous pre-mix suspension concentrate formula having a decomposition rate of less than 20% over 2 years comprising:
(i) water,
(ii) an HPPD inhibitor, in suspension in the water, and
(iii) an electrolyte, in solution in the water.

2. A formulation according to claim 1, wherein the HPPD inhibitor is selected from the groups consisting of isoxazoles, triketones, pyrazoles, benzobicyclon and ketospiradox.

3. A formulation according to claim 2, wherein the isoxazole is a compound of formula (IA) 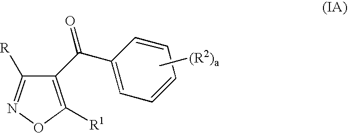
wherein R is hydrogen or —CO₂R³;
R¹ is C₁₋₄ alkyl or C₃₋₆ cycloalkyl optionally substituted by C₁₋₆ alkyl;
R² is independently selected from halogen, nitro, cyano, C₁₋₄ alkyl, C₁₋₄ haloalkyl, C₁₋₆ alkoxy, C₁₋₄ haloalkoxy, —(CR⁴R⁵)CS(O)_{b}R⁶, —S(O)_{b}R⁶, —OSO₂R⁶ and —N(R⁷)SO₂R⁶;
or two groups R², on adjacent carbon atoms of the phenyl ring may, together with the carbon atoms to which they are attached, form a 5- or 6-membered saturated or unsaturated heterocyclic ring containing up to three ring heteroatoms selected from nitrogen, oxygen and sulphur, which ring may be optionally substituted by one or more groups selected from halogen, nitro, C₁₋₄ alkyl, C₁₋₄ alkoxy, C₁₋₄ haloalkyl, C₁₋₄ haloalkoxy and —S(O)_{b}R⁵, it being understood that a sulphur atom, where present in the ring, may be in the form of a group —SO— or —SO₂—;
R³ is C₁₋₄ alkyl;
R⁴ and R⁵ are independently hydrogen or C₁₋₄ alkyl;
R⁶ is C₁₋₄ alkyl, or phenyl or benzyl, each of phenyl and benzyl optionally bearing from one or five substituents which may be the same of different selected from the group consisting of halogen, C₁₋₄ alkyl, C₁₋₄ alkoxy, C₁₋₄ haloalkyl, C₁₋₄ haloalkoxy, nitro and —S(O)_{b}CH₃;
R⁷ is hydrogen or C₁₋₆ alkyl;
a is an integer from one to five;
b is zero, one or two; and
c is one or two (where c is two, the groups (CR⁴R⁵) may be the same or different).

4. A formulation according to claim 2, wherein the triketone is a compound of formula (IB), 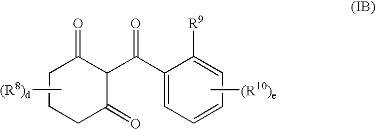
wherein each R³ independently represents (C₁₋₄)alkyl or —CO₂R¹¹;
R⁹ represents a halogen atom; a straight- or branched-chain alkyl or alkoxy group containing up to six carbon atoms which is optionally substituted by one or more groups —OR¹² or one or more halogen atoms; or a group selected from nitro, cyano, —CO₂R¹³, —S(O)_{f}R¹², —O(CH₂)_{g}OR¹², —COR¹³,—NR¹³R¹⁴, —SO₂NR¹³R¹⁴, —CONR¹³R¹⁴, —CSNR¹³R¹⁴ and —OSO₂R¹⁵;
each R¹⁰ independently represents halo, nitro, cyano, S(O)_{f}R¹⁶, OS(O)_{f}R¹⁶, C₁₋₆alkyl, C₁₋₆ alkoxy, C₁₋₆ haloalkyl, C₁₋₆ haloalkoxy, carboxy, C₁₋₆ alkylcarbonyloxy, C₁₋₆ alkoxycarbonyl, C₁₋₆ alkylcarbonyl, amino, C₁₋₆ alkylamino, C₁₋₆ dialkylamino having independently the stated number of carbon atoms in each alkyl group, C₁₋₆ alkylcarbonylamino, C₁₋₆ alkoxycarbonylamino, C₁₋₆ alkylaminocarbonylamino, C₁₋₆ dialkylaminocarbonylamino having independently the stated number of carbon atoms in each alkyl group, C₁₋₆alkoxycarbonyloxy, C₁₋₆alkylaminocarbonyloxy, C₁₋₆ dialkylcarbonyloxy, phenylcarbonyl, substituted phenylcarbonyl, phenylcarbonyloxy, substituted phenylcarbonyloxy, phenylcarbonylamino, substituted phenylcarbonylamino, phenoxy or substituted phenoxy;
R¹¹ is C₁₋₄alkyl;
R¹² represents a straight- or branched-chain alkyl group containing up to six carbon atoms which is optionally substituted by one or more halogen atoms;
R¹³ and R¹⁴ each independently represents a hydrogen atom; or a straight- or branched-chain alkyl group containing up to six carbon atoms which is optionally substituted by one or more halogen atoms;
R¹⁵ represents a straight- or branched-chain alkyl, alkenyl or alkynyl group containing up to six carbon atoms optionally substituted by one or more halogen atoms; or a cycloalkyl group containing from three to six carbon atoms;
R¹⁶ represents a straight or branched-chain alkyl group containing up to six carbon atoms;
d is zero or an integer from one to six;
e is zero or an integer from one to four;
f is zero, one or two; and
g is one, two or three;
with the exception of 2-(2′chloro-4′-methylsulphonylbenzoyl)-1,3-cyclohexanedione.

5. A formulation according to claim 2, wherein the triketone is a compound of formula (IC) 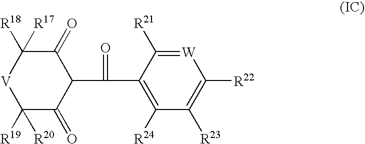
wherein V is C₁₋₂ alkylene, which may be mono- or poly-substituted by R²⁶; or, when R¹⁸ and R¹⁹ are other than C₂₋₃ alkylene, V may additionally be carbonyl, oxygen or —NR²⁷—;
W is CR²³ or N(O)_{g};
R¹⁷, R¹⁸, R¹⁹ and R²⁰ are independently hydrogen, C₁₋₄ alkyl, phenyl, C₁₋₄ alkoxy, halogen, hydroxy, cyano, hydroxycarbonyl or C₁₋₄ alkoxycarbonyl; or R¹³ and R¹⁹ together are C₂₋₃ alkylene, which may be mono- or poly-substituted by R²⁵;
R²¹ is hydrogen, C₁₋₆ alkyl, C₁₋₆ haloalkyl, C₂₋₆ alkenyl, C₂₋₆ haloalkenyl, C₁₋₂ alkoxycarbonyl- or phenyl-substituted vinyl, C₂₋₆ alkynyl, C₂₋₆ haloalkynyl, trimethylsilyl-, hydroxy-, C₁₋₆ alkoxy-, C-alkoxycarbonyl- or phenyl-substituted ethynyl, C₃₋₆ allenyl, C₃₋₆ cycloalkyl, halo- or C₁₋₃ alkoxymethyl-substituted C₃₋₆ cycloalkyl, C₁₋₆ alkoxy, C₃₋₆ alkenyloxy, C₃₋₆ alkynyloxy, C₁₋₆ haloalkoxy, C₃₋₆ haloalkenyloxy, cyano-C₁₋₄ alkoxy, C₁₋₄ alkoxy-C₁₋₄ alkoxy, C₁₋₄ alkylthio-C₁₋₄ alkoxy, C₁₋₄ alkylsulfinyl-C₁₋₄ alkoxy, C₁₋₄ alkylsulfonyl-C₁₋₄ alkoxy, C₁₋₄ alkoxycarbonyl-C₁₋₄ alkoxy, C₁₋₆ alkylthio, C₁₋₆-alkylsulfinyl, C₁₋₆ alkylsulfonyl, C₁₋₆ haloalkylthio, C₁₋₆ haloalkylsulfinyl, C₁₋₆ haloalkylsulfonyl, C₁₋₄ alkoxycarbonyl-C₁₋₄ alkylthio, C₁₋₄ alkoxycarbonyl-C₁₋₄ alkylsulfinyl, C₁₋₄ alkoxycarbonyl-C₁₋₄ alkylsulfonyl, C₁₋₆ alkylamino, di(C₁₋₆ alkyl)amino, C₁₋₃ alkoxy-C₁₋₃ alkylamino, C₁₋₃ alkoxy-C₁₋₃ alkyl-N(C₁₋₃ alkyl), C₁₋₆ alkylaminosulfonyl, di(C₁₋₆ alkyl)aminosulfonyl, C₁₋₄ alkylsulfonyloxy, C₁₋₄ haloalkylsulfonyloxy, C₁₋₄alkylsulfonylamino, C₁₋₄ alkylsulfonyl-N(C₁₋₄ alkyl), cyano, carbamoyl, C₁₋₄ alkoxycarbonyl, formyl, halogen, rhodano, amino, hydroxy-C₁₋₄ alkyl, C₁₋₄ alkoxy-C₁₋₄ alkyl, C₁₋₄ alkylthio-C₁₋₄ alkyl, C₁₋₄ alkylsulfinyl-C₁₋₄ alkyl, C₁₋₄ alkylsulfonyl-C₁₋₄ alkyl, cyano-C₁₋₄ alkyl, C₁₋₆ alkyl-carbonyloxy-C₁₋₄ alkyl, C₁₋₄ alkoxycarbonyl-C₁₋₄ alkyl, C₁₋₄ alkoxycarbonyloxy-C₁₋₄ alkyl, rhodano-C₁₋₄ alkyl, phenyl-C₁₋₄ alkyl, phenoxy-C₁₋₄ alkyl, benzyloxy-C₁₋₄ alkyl, benzoyloxy-C₁₋₄ alkyl, (2-oxiranyl)-C₁₋₄ alkyl, C₁₋₄ alkylamino-C₁₋₄ alkyl, di(C₁₋₄ alkyl)amino-C₁₋₄ alkyl, C₁₋₁₂ alkylthiocarbonyl-C₁₋₁₄ alkyl or formyl-C₁₋₄alkyl, or benzylthio, benzylsulfinyl, benzylsulfonyl, benzyloxy, benzyl, phenyl, phenoxy, phenylthio, phenylsulfinyl or phenylsulfonyl, wherein the phenyl-containing groups may themselves be substituted by C₁₋₃ alkyl, C₁₋₃ haloalkyl, C₁₋₃ alkoxy, C₁₋₃ haloalkoxy, halogen, cyano or by nitro; or R²¹ is a three- to ten-membered monocyclic or fused bicyclic ring system, which may be aromatic, saturated or partially saturated and may contain from 1 to 4 hetero atoms selected from nitrogen, oxygen and sulfur, wherein the ring system is bonded to the group W-containing aromatic ring by way of a C₁₋₄ alkylene, C₂₋₄ alkenylene or C₂₋₄ alkynylene bridge which may be interrupted by oxygen, —N(C₁₋₄ alkyl)-, sulfur, sulfinyl, sulfonyl or by carbonyl, and each ring system may contain no more than two oxygen atoms and no more than two sulfur atoms, and the ring system may itself be mono-, di- or tri-substituted by C₁₋₆ alkyl, C₁₋₆ haloalkyl, C₂₋₆ alkenyl, C₂₋₆ haloalkenyl, C₂₋₆ alkynyl, C₂₋₆ haloalkynyl, C₁₋₆ alkoxy, C₁₋₆ haloalkoxy, C₃₋₆ alkenyloxy, C₃₋₆ alkynyloxy, hydroxy, mercapto, C₁₋₆ alkylthio, C₁₋₆ haloalkylthio, C₃₋₆ alkenylthio, C₃₋₆ haloalkenylthio, C₃₋₆ alkynylthio, C₁₋₄ alkoxy-C₁₋₃ alkylthio, C₁₋₄ alkylcarbonyl-C₁₋₃ alkylthio, C₁₋₄ alkoxycarbonyl-C₁₋₃ alkylthio, cyano-C₁₋₃ alkylthio, C₁₋₆ alkylsulfinyl, C₁₋₆ haloalkylsulfinyl, C₁₋₆ alkylsulfonyl, C₁₋₆ haloalkylsulfonyl, aminosulfonyl, C₁₋₄ alkylaminosulfonyl, di(C₁₋₄alkyl)aminosulfonyl, di(C₁₋₄alkyl)amino, halogen, cyano, nitro, phenyl and/or by benzylthio, wherein phenyl and benzylthio may themselves be substituted on the phenyl ring by C₁₋₃ alkyl, C₁₋₃ haloalkyl, C₁₋₃ alkoxy, C₁₋₃ haloalkoxy, halogen, cyano or by nitro, and wherein substituents on the nitrogen in the heterocyclic ring are other than halogen; or
R²¹ is the group -D₁-D₃ or the group -D₂-D₁-D₃;
R²² is hydrogen, C₁₋₆ alkyl, C₁₋₆ haloalkyl, C₂₋₆ alkenyl, C₂₋₆ haloalkenyl, C₂₋₆ alkynyl, C₂₋₆ haloalkynyl, C₃₋₆ cycloalkyl, C₁₋₆ alkoxy, C₁₋₆ haloalkoxy, C₁₋₆ alkylthio, C₁₋₆ alkylsulfinyl, C₁₋₆ alkylsulfonyl, C₁₋₆ haloalkylthio, C₁₋₆ haloalkylsulfinyl, C₁₋₆ haloalkylsulfonyl, C₁₋₆ alkylsulfonyloxy, hydroxy, mercapto, amino, C₁₋₆ alkylamino, di(C₁₋₆ alkyl)amino, C₁₋₄ alkylsulfonylamino, C₁₋₄ alkylsulfonyl-N(C₁₋₄ alkyl)-, C₁₋₆ alkylaminosulfonyl, di(C₁₋₆ alkyl)aminosulfonyl, cyano, halogen, C₁₋₄ alkoxy-C₁₋₄ alkyl, C₁₋₄ alkylthio-C₁₋₄ alkyl, C₁₋₄ alkylsulfinyl-C₁₋₄ alkyl, C₁₋₄ alkylsulfonyl-C₁₋₄ alkyl, triazolyl, phenyl, phenylthio, phenylsulfinyl, phenylsulfonyl or phenoxy, wherein the phenyl-containing groups may be substituted by C₁₋₃ alkyl, C₁₋₃ haloalkyl, C₁₋₃ alkoxy,
C₁₋₃ haloalkoxy, halogen, cyano or by nitro;
R²³ is hydrogen, C₁₋₆ alkyl, hydroxy, C₁₋₆ alkoxy, C₁₋₆ haloalkoxy, C₃₋₆ alkenyloxy, C₃₋₆ haloalkenyloxy, C₃₋₆ alkynyloxy, C₁₋₄ alkylcarbonyloxy, C₁₋₄ alkylsulfonyloxy, phenylsulfonyloxy, C₁₋₄ alkylthio, C₁₋₄ alkylsulfinyl, C₁₋₄ alkylsulfonyl, C₁₋₄ alkylamino, di(C₁₋₄ alkyl)amino, C₁₋₄ alkoxycarbonyl, C₁₋₄ haloalkyl, formyl, cyano, halogen, phenyl or phenoxy, wherein the phenyl-containing groups may themselves be substituted by C₁₋₃ alkyl, C₁₋₃ haloalkyl, C₁₋₃ alkoxy, C₁₋₃ haloalkoxy, halogen, cyano or by nitro; or R²³ is a three- to ten-membered monocyclic or, together with R²⁵ or R²⁷, fused bicyclic ring system, which may contain from 1 to 4 hetero atoms selected from nitrogen, oxygen and sulfur, wherein, when the ring system is not fused, it is bonded to the W-containing aromatic ring, either directly or by way of a C₁₋₄ alkylene, C₂₋₄ alkenylene or C₂₋₄ alkynylene bridge which may be interrupted by oxygen, —N(C₁₋₄ alkyl)-, sulfur, sulfinyl, sulfonyl or by carbonyl, and the ring system may contain no more than two oxygen atoms and no more than two sulfur atoms, and the ring system may itself be mono-, di- or tri-substituted by C₁₋₆ alkyl, C₁₋₆ haloalkyl, C₂₋₆ alkenyl, C₂₋₆ haloalkenyl, C₂₋₆ alkynyl, C₂₋₆ haloalkynyl, C₁₋₆ alkoxy, C₁₋₆ haloalkoxy, C₃₋₆ alkenyloxy, C₃₋₆ alkynyloxy, C₁₋₆ alkylthio, C₁₋₆ haloalkylthio, C₃₋₆ alkenylthio, C₃₋₆ haloalkenylthio, C₃₋₆ alkynylthio, C₁₋₄ alkoxy-C₁₋₂ alkylthio, C₁₋₄ alkylcarbonyl-C₁₋₂ alkylthio, C₁₋₄ alkoxycarbonyl-C₁₋₂ alkylthio, cyano-C₁₋₄ alkylthio, C₁₋₆ alkylsulfinyl, C₁₋₆ haloalkylsulfinyl, C₁₋₆ alkylsulfonyl, C₁₋₆ haloalkylsulfonyl, aminosulfonyl, C₁₋₄ alkylaminosulfonyl, di(C₁₋₄alkyl)aminosulfonyl, amino, C₁₋₄alkylamino, di(C₁₋₄alkyl)amino, halogen, cyano, nitro, phenyl and by/or benzylthio, wherein phenyl and benzylthio may themselves be substituted on the phenyl ring by C₁₋₃ alkyl, C₁₋₃ haloalkyl, C₁₋₃ alkoxy, C₁₋₃ haloalkoxy, halogen, cyano or by nitro, and wherein substituents on the nitrogen in the heterocyclic ring are other than halogen;
R²⁴ is hydrogen, C₁₋₆ alkyl, C₁₋₆ haloalkyl, C₂₋₆ alkenyl, C₂₋₆ haloalkenyl, C₂₋₆ alkynyl, C₂₋₆ haloalkynyl, C₃₋₆ cycloalkyl, C₁₋₆ alkoxy, C₁₋₆ haloalkoxy, C₁₋₆ alkylthio, C₁₋₆ alkylsulfinyl, C₁₋₆ alkylsulfonyl, C₁₋₆ haloalkylthio, C₁₋₆haloalkylsulfinyl, C₁₋₆haloalkylsulfonyl, amino, C₁₋₆alkylamino, di(C₁₋₆alkyl)amino, C₁₋₄ alkylsulfonyl-N(C₁₋₄ alkyl)-, C₁₋₆ alkylaminosulfonyl, di(C₁₋₆ alkyl)aminosulfonyl, cyano, halogen, C₁₋₄ alkoxy-C₁₋₄ alkyl, C₁₋₄ alkylthio-C₁₋₄ alkyl, C₁₋₄ alkylsulfinyl-C₁₋₄ alkyl, C₁₋₄ alkylsulfonyl-C₁₋₄ alkyl, phenyl, phenylthio, phenylsulfinyl, phenylsulfonyl or phenoxy, wherein phenyl groups may themselves be substituted by C₁₋₃ alkyl, C₁₋₃ haloalkyl, C₁₋₃ alkoxy, C₁₋₃ haloalkoxy, halogen, cyano or by nitro;
R²⁵ and R²⁶ are each independently hydrogen, C₁₋₄alkyl, phenyl, C₁₋₄alkoxy, halogen, hydroxy, cyano, hydroxycarbonyl or C₁₋₄ alkoxycarbonyl;
R²⁷ is C₁₋₄ alkyl, alkoxycarbonyl or C₁₋₄ alkylcarbonyl;
R²⁸ is hydrogen, C₁₋₆ alkyl, hydroxy, C₁₋₆ alkoxy, C₁₋₆ haloalkoxy, C₃₋₆ alkenyloxy, C₃₋₆ haloalkenyloxy, C₃₋₆ alkynyloxy, C₁₋₄ alkylcarbonyloxy, C₁₋₄ alkylsulfonyloxy, phenylsulfonyloxy, C₁₋₆ alkylthio, C₁₋₆ alkylsulfinyl, C₁₋₆ alkylsulfonyl, C₁₋₆ alkylamino, di(C₁₋₁₆ alkyl)amino, C₁₋₃ alkoxy-C₁₋₁₃ alkylamino, C₁₋₃ alkoxy-C₁₋₃ alkyl-N(C₁₋₃ alkyl)-, C₁₋₄ alkoxycarbonyl, C₁₋₆ haloalkyl, formyl, cyano, halogen, phenyl or phenoxy, wherein the phenyl-containing groups may themselves be substituted by C₁₋₃ alkyl, C₁₋₃ haloalkyl, C₁₋₃ alkoxy, C₁₋₃ haloalkoxy, halogen, cyano or by nitro;
or R²³ is a three- to ten-membered monocyclic or, together with R²¹ or R²² fused bicyclic ring system, which may be interrupted once or up to three times by heterocyclic substituents selected from oxygen, sulfur, S(O), SO₂, N(R²⁹), carbonyl and C(═NOR³⁰), and wherein, when the ring system is not fused, it is bonded to the carbon atom of the substituent W, either directly or by way of a C₁₋₄ alkylene, C₂₋₄ alkenylene or C₂₋₄ alkynylene bridge which may be interrupted by oxygen, —N(C₁₋₄ alkyl)-, sulfur, sulfinyl or by sulfonyl, and the ring system may contain no more than two oxygen atoms and no more than two sulfur atoms, and the ring system may itself be mono-, di- or tri-substituted by C₁₋₆ alkyl, C₁₋₆ haloalkyl, C₂₋₆ alkenyl, C₂₋₆ haloalkenyl, C₂₋₆ alkynyl, C₂₋₆ haloalkynyl, C₁₋₆ alkoxy, C₁₋₆ haloalkoxy, C₃₋₆ alkenyloxy, C₃₋₆ alkynyloxy, C₁₋₆ alkylthio, C₁₋₆ haloalkylthio, C₃₋₆ alkenylthio, C₃₋₆ haloalkenylthio, C₃₋₆ alkynylthio, C₁₋₄ alkoxy-C₁₋₂ alkylthio, C₁₋₄ alkylcarbonyl-C₁₋₂-alkylthio, C₁₋₄ alkoxycarbonyl-C₁₋₂ alkylthio, cyano-C₁₋₄ alkylthio, C₁₋₆ alkylsulfinyl, C₁₋₆ haloalkyl-sulfinyl, C₁₋₆ alkylsulfonyl, C₁₋₆ haloalkylsulfonyl, aminosulfonyl, C₁₋₄ alkylaminosulfonyl, di(C₁₋₄ alkyl)aminosulfonyl, di(C₁₋₄alkyl)amino, halogen, cyano, nitro, phenyl, benzyloxy and/or by benzylthio, and wherein the phenyl-containing groups may themselves be substituted on the phenyl ring by C₁₋₃ alkyl, C₁₋₃ haloalkyl, C₁₋₃ alkoxy, C₁₋₃ haloalkoxy, halogen, cyano or by nitro, and wherein substituents on the nitrogen in the heterocyclic ring are other than halogen;
or R²⁸ is the group -D₄-D₆ or the group -D₅-D₄-D₆;
R²⁹ is hydrogen, C₁₋₄ alkyl, C₁₋₄ alkylthio-C₁₋₄ alkylcarbonyl, C₁₋₄ alkylsulfinyl-C₁₋₄ alkylcarbonyl, C₁₋₄ alkylsulfonyl-C₁₋₄ alkylcarbonyl, C₁₋₄ alkoxycarbonyl, C₁₋₄ alkylcarbonyl, phenylcarbonyl or phenyl, wherein the phenyl groups may themselves be substituted by C₁₋₄ alkyl, C₁₋₄ haloalkyl, C₁₋₄ alkoxy, C₁₋₄ haloalkoxy, C₁₋₄ alkylcarbonyl, C₁₋₄ alkoxycarbonyl, C₁₋₄ alkylamino, di(C₁₋₄ alkyl)amino, C₁₋₄ alkylthio, C₁₋₄ alkylsulfinyl, C₁₋₄ alkyl-SO₂, C₁₋₄ alkyl-S(O)₂O, C₁₋₄ haloalkylthio, C₁₋₄ haloalkylsulfinyl, C₁₋₄ haloalkyl-SO₂, C₁₋₄ haloalkyl-S(O)₂O, C₁₋₄ alkyl-S(O)₂NH, C₁₋₄ alkyl-S(O)₂N(C₁₋₄ alkyl)-, halogen, nitro or by cyano;
R³⁰ is hydrogen, C₁₋₄ alkyl, C₃₋₄ alkenyl, C₃₋₄ alkynyl or benzyl;
h is 0 or 1;
D₁ is oxygen, —O(CO)—, —(CO)O—, —O(CO)O—, —N(C₁₋₄ alkyl)-O—, —O—N(C₁₋₄ alkyl)-, thio, sulfinyl, sulfonyl, —SO₂N(C₁₋₄ alkyl)-, —N(C₁₋₄ alkyl)SO₂—, —N(C₁₋₂ alkoxy-C₁₋₂ alkyl)SO₂— or —N(C₁₋₄ alkyl)-;
D₂ is a C₁₋₆ alkylene, C₃₋₆ alkenylene or C₃₋₆ alkynylene chain, which may be mono- or poly-substituted by halogen or by D₇, the unsaturated bonds of the chain not being bonded directly to the substituent D₁;
D₃ and D₆ are each independently of the other a C₁₋₈ alkyl, C₃₋₆ alkenyl or C₃₋₆ alkynyl group, which may be mono- or poly-substituted by halogen, hydroxy, amino, formyl, nitro, cyano, mercapto, carbamoyl, C₁₋₆ alkoxy, C₁₋₆ alkoxycarbonyl, C₂₋₆ alkenyl, C₂₋₆ haloalkenyl, C₂₋₆ alkynyl, C₂₋₆ haloalkynyl, C₃₋₆ cycloalkyl, halo-substituted C₃₋₆ cycloalkyl, C₃₋₆ alkenyloxy, C₃₋₆ alkynyloxy, C₁₋₆ haloalkoxy, C₃₋₆ haloalkenyloxy, cyano-C₁₋₆ alkoxy, C₁₋₆ alkoxy-C₁₋₆ alkoxy, C₁₋₆ alkoxy-C₁₋₆ alkoxy-C₁₋₆ alkoxy, C₁₋₆ alkylthio-C₁₋₆ alkoxy, C₁₋₆ alkylsulfinyl-C₁₋₆ alkoxy, C₁₋₆ alkylsulfonyl-C₁₋₆ alkoxy, C₁₋₆ alkoxycarbonyl-C₁₋₆ alkoxy, C₁₋₆ alkoxycarbonyl, C₁₋₆ alkylcarbonyl, C₁₋₆ alkylthio, C₁₋₆ alkylsulfinyl, C₁₋₆ alkylsulfonyl, C₁₋₆ haloalkylthio, C₁₋₆ haloalkylsulfinyl, C₁₋₆ haloalkylsulfonyl, oxiranyl which may itself be substituted by C₁₋₆ alkyl, (3-oxetanyl)-oxy which may itself be substituted by C₁₋₆ alkyl, benzyloxy, benzylthio, benzylsulfinyl, benzylsulfonyl, C₁₋₆ alkylamino, di(C₁₋₆ alkyl)amino, C₁₋₄ alkyl-S(O)₂O, di(C₁₋₄alkyl)aminosulfonyl, rhodano, phenyl, phenoxy, phenylthio, phenylsulfinyl or by phenylsulfonyl, and wherein the phenyl- or benzyl-containing groups may themselves be substituted by one or more C₁₋₆ alkyl, C₁₋₆ haloalkyl, C₁₋₆ alkoxy, C₁₋₆ haloalkoxy, halogen, cyano, hydroxy or nitro groups; or
D₃ and D₆ are each independently of the other phenyl, which may be mono- or poly-substituted by C₁₋₆ alkyl, C₁₋₆ haloalkyl, C₁₋₆ alkoxy, C₁₋₆ haloalkoxy, halogen, cyano, hydroxy or by nitro; or
D₃ and D₆ are each independently of the other C₃₋₆ cycloalkyl, C₁₋₆ alkoxy- or C₁₋₆ alkyl-substituted C₃₋₆ cycloalkyl, 3-oxetanyl or C₁₋₆ alkyl-substituted 3-oxetanyl; or
D₃ and D₆ are each independently of the other a three- to ten-membered monocyclic or fused bicyclic ring system, which may be aromatic, saturated or partially saturated and may contain from 1 to 4 hetero atoms selected from nitrogen, oxygen and sulfur, wherein the ring system is bonded to the substituent D₁ or D₄ directly or by way of a C₁₋₄ alkylene, C₂₋₄ alkenylene, C₂₋₄ alkynylene, —N(C₁₋₄ alkyl)-C₁₋₄ alkylene, —S(O)—C₁₋₄ alkylene or —SO₂—C₁₋₄ alkylene group, and each ring system may contain no more than two oxygen atoms and no more than two sulfur atoms, and the ring system may itself be mono-, di- or tri-substituted by C₁₋₆ alkyl, C₁₋₆ haloalkyl, C₂₋₆ alkenyl, C₂₋₆ haloalkenyl, C₂₋₆ alkynyl, C₂₋₆ haloalkynyl, C₁₋₆ alkoxy, hydroxy, C₁₋₆ haloalkoxy, C₃₋₆ alkenyloxy, C₃₋₆ alkynyloxy, mercapto, C₁₋₆ alkylthio, C₁₋₆ haloalkylthio, C₃₋₆ alkenylthio, C₃₋₆ haloalkenylthio, C₃₋₆ alkynylthio, C₁₋₃ alkoxy-C₁₋₃ alkylthio, C₁₋₄ alkylcarbonyl-C₁₋₂ alkylthio, C₁₋₄ alkoxycarbonyl-C₁₋₂ alkylthio, cyano-C₁₋₃ alkylthio, C₁₋₆ alkylsulfinyl, C₁₋₆ haloalkylsulfinyl, C₁₋₆ alkylsulfonyl, C₁₋₆ haloalkylsulfonyl, aminosulfonyl, C₁₋₂alkylaminosulfonyl, di(C₁₋₂alkyl)aminosulfonyl, di(C₁₋₄alkyl)amino, C₁₋₆ carbonylamino, halogen, cyano, nitro, phenyl, benzyloxy and/or by benzylthio, wherein the phenyl groups may themselves be substituted on the phenyl ring by C₁₋₃ alkyl, C₁₋₃ haloalkyl, C₁₋₃ alkoxy, C₁₋₃ haloalkoxy, halogen, cyano or by nitro, and wherein the substituents on the nitrogen in the heterocyclic ring are other than halogen;
D₄ is oxygen, —O(CO)—, —(CO)O—, —O(CO)O—, —N(C₁₋₄ alkyl)-O—, —O—N(C₁₋₄ alkyl)-, sulfur, sulfinyl, sulfonyl, —SO₂N(C₁₋₄ alkyl)-, —N(C₁₋₄ alkyl)SO₂—, —N(C₁₋₂ alkoxy-C₁₋₂ alkyl)SO₂— or —N(C₁₋₄ alkyl)-;
D₅ is a C₁₋₆ alkylene, C₃₋₆ alkenylene or C₃₋₆ alkynylene chain, which may be mono- or poly-substituted by halogen or by D₈, the unsaturated bonds of the chain not being bonded directly to the substituent D₄;
D₇ and D₈ are each independently of the other hydroxy, C₁₋₆ alkoxy, (C₃₋₆ cycloalkyl)oxy, C₁₋₆ alkoxy-C₁₋₆ alkoxy, C₁₋₆ alkoxy-C₁₋₆ alkoxy-C₁₋₆ alkoxy or C₁₋₆ alkylsulfonyloxy;
and agronomically acceptable salts/N-oxides/isomers/enantiomers of such compounds.

6. A formulation according to claim 2, wherein the triketone is a compound of formula (ID) 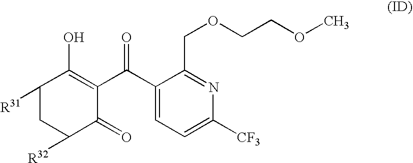
wherein R³¹ and R³² are both hydrogen or together form an ethylene bridge.

7. A formulation according to claim 2, wherein the pyrazole is a compound of formula (IE) 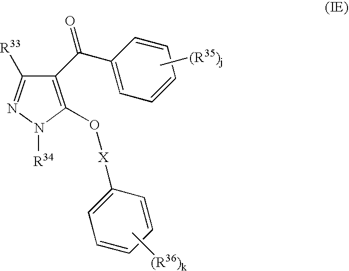
wherein R³³, R³⁴, R³⁵ and R³⁶ are each independently selected from hydrogen, halo or C₁₋₄ alkyl;
X is —SO₂— or —CH₂CO—;
j is 2 or 3; and
k is zero or 1.

8. A formulation according to claim 2, wherein the pyrazole is a compound of formula (IF) 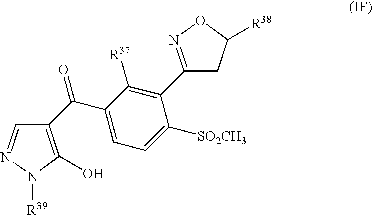
wherein R³⁷ is C₁₋₂ alkyl or chloro; R³⁸ is hydrogen or C₁₋₄ alkyl; and R³⁹ is C₁₋₄ alkyl.

9. A formulation according to claim 1, wherein the HPPD inhibitor is benzobicyclon.

10. A formulation according to claim 1, wherein the HPPD inhibitor is ketospiradox.

11. A formulation according to claim 1, wherein the electrolyte is selected from the group consisting of a simple ionic species or an additional active ingredient.

12. A formulation according to claim 1, wherein the ratio of HPPD inhibitor to electrolyte in the formulation is from 70:1 to 1:5.

13. A formulation according to claim 1, wherein the concentration of HPPD inhibitor in the formulation is from 10 to 600 g/l.

14. A formulation according to claim 1, wherein the concentration of electrolyte in the formulation is from 10 to 700 g/l.

15. A process for the preparation of a formulation according to claim 1, said process comprising the steps of
(i) separately preparing a HPPD inhibitor millbase and an electrolyte solution, and
(ii) adding the HPPD inhibitor millbase and the electrolyte solution to water.

16. A process for the control of unwanted vegetation, said process comprising the dilution of a formulation according to claim 1 to form a ready-to-use aqueous formulation, followed by the application of a herbicidally effective amount of said ready-to-use aqueous formulation to the locus of the unwanted vegetation.

17. A process for improving the stability of an HPPD inhibitor in an aqueous concentrate formulation, said process comprising the addition of a HPPD inhibitor-stabilising amount of an electrolyte to said aqueous formulation.
